(19) United States
(12) Patent Application Publication
(10) Pub. No.: US 2010/0270759 A1
(43) Pub. Date: Oct. 28, 2010

(54) Tool bit holder assembly

(76) Inventor: Daniel Huang, Dali City (TW)

Correspondence Address: Daniel Huang, P. O. Box 44-2049, Taipei, 10668, TW

(21) Appl. No.: 12/801,991

(22) Filed: Jul. 7, 2010

Related U.S. Application Data
(63) Continuation-in-part of application No. 11/289,585, filed on Nov. 30, 2005, now Pat. No. 7,159,493.

(51) Int. Cl. B23B 31/107

(52) U.S. Cl. 279/80

(57) ABSTRACT

A bit holder assembly includes a socket with a sleeve movably mounted thereto and two springs are located between the socket and the sleeve. The two springs have two respective end sections which are engaged with two inclined slots defined in the wall of the socket. The two end sections protrude into ⅕ of the inner diameter of the socket. An inner spring is located in the socket. The axial height of the first slot is larger than or equal to the axial height of the notches of the bit, and the axial height of the second slot is larger than or equal to an axial height of the annular groove of the bit. An angle between the axis of the socket and the first and second slots is smaller than 60 degrees.

This application is a Continuation-In-Part application of applicant's former U.S. Pat. No. 7,159,493, filed on Nov. 30, 2005.

### BACKGROUND OF THE INVENTION

(1) Field of the Invention

(2) Description of the Prior Art

A conventional tool bit holder assembly is shown in FIGS. 1 to 3, and generally includes a socket 10 which includes a spiral groove 11 defined in a wall thereof and a spring 12 is mounted to the socket 10. An end section 121 of the spring 12 is inserted into the spiral groove 11 and protrudes into the reception hole 13 of the socket 10. The end section 121 of the spring 12 is used to be engaged with the groove 2 of the tool bit 1. When the bit is inserted into the reception hole 13, the end section 121 is pushed outward by the body of the bit 1 and when the push force is disappeared, the end section 121 is engaged with the groove 2 to position the bit 1. When the sleeve 14 is pulled, the end section 121 is pulled into the spiral groove 11 and the bit 1 is pushed out from the socket 10 by an inner spring 15 in the reception hole 13.

If the end section 121 protrudes into the reception hole 13 too long, the bit 1 is difficult to be inserted into the reception hole 13 and the spring 12 is easily jammed at the inside of the reception hole 13. The spring 12 also affects the removal of the bit 1 from the reception hole 13. On the contrary, if the end section 121 is too short and is not properly protruded into the reception hole 13, the bit 1 is not well positioned and may drop from the reception hole 13 during use. As shown in FIG. 4, the end section 121 is located at the bottom of the bit 1 and the sleeve 14 has to be pulled downward to let the end section 121 to move outward so that the bit 1 is able to be inserted into the reception hole 13. If the user inserts the bit 1 into the reception hole 13 without pulling the sleeve 14, the spring 12 is jammed.

FIG. 5 shows another bit holder assembly and includes a socket 20, an inner sleeve 21 and an attraction unit 22, wherein the socket 20 has a reception hole 23 in one end thereof so as to receive a bit 3 therein and a slot 24 is defined through the wall of the socket 20. The inner sleeve 21 is mounted to the socket 20 and includes a hole 25 which is located corresponding to the slot 24 so that a ball 26 is received in the slot 25 and the hole 25. An outer sleeve 27 is mounted to the socket 20 and the inner sleeve 21. A shoulder 271 is formed in the inside of the outer sleeve 27 and located corresponding to the ball 26. A spring 28 is located between the outer sleeve 27 and the inner sleeve 32. When the ball 26 is pushed by the shoulder 271, a part of the ball 26 is inserted into the slot 24 and is located at the trace of the insertion of the bit 3. The attraction unit 22 is located in the reception hole 23 and includes a spring 221 and a magnet 222. When the bit 3 is inserted into the reception hole 23, the spring 221 is compressed and the bit 3 is attracted by the magnet 222. When the force applied to the bit 3 is disappeared, the spring 28 pushed the bit 3 while the bit 3 is still attracted by the magnet 222 so that user can easily pick the bit 3 out from the reception hole 23.

However, the ball 26 cannot position the bits 3 of different specifications. Referring to FIGS. 6 and 7, there are several different types of bits are used, such as the C type bit 3 having notches 4 and the E type bit 1 having an annular groove 2. The positioning ball 26 of the conventional socket 20 can only be used for the C type bit 3 with notches 4 and cannot well position the E type bit with the annular groove 2. If the bit 3 is a dual-end bit, one end of the bit is inserted into the socket 20 and may be jammed with the spring 221 or deform the spring 221 so that the conventional bit holder assembly cannot properly position the dual-end bit.

FIGS. 8 and 9 show yet another conventional bit holder assembly and which includes a socket 30 and a sleeve 37, the socket 30 receives a bit 301 and a spring 32 therein. The spring 32 is positioned at the lower end of the socket 30 by a collar 33 and an inclined slot 31 is defined in a mediate portion of the socket 30. The spring 38 is mounted to the socket 30 and the lower end of the spring 38 is rested on the flange 35 of the socket 30 and the top end of the spring 38 is biased to a piece 39 which is inserted into the inclined slot 31. The socket 30 has a groove 341 in a top end thereof so as to receive a collar 34 therein to prevent the sleeve 37 from being separated from the sleeve 37.

When in use, the bit 301 is inserted into the socket 30 and the piece 39 is pushed to move slightly downward so that the bit 301 is successfully inserted into the socket 30 and compresses the spring 32. The piece 39 then is moved into the inclined slot 31 by the spring 38 and is engaged with the groove 302 of the bit 301 which is then positioned.

As shown in FIG. 9, the sleeve 37 is pulled downward to move the piece 39 downward and the piece 39 is removed from the groove 302 so that the bit 301 can be pulled out from the socket 30.

The positioning device for the socket 30 cannot be used to position the dual-end bit 301a, as shown in FIG. 10, the end of the bit 301a is inserted into the socket 30 and the spring 32 in the socket 32 may be tangled or jammed by the end of the bit 301a and the spring 32 may be deformed. If the bit 3 has notches 4 and does not have the groove 302b, as shown in FIG. 5, because the height and depth of the groove 302b and the notches 4 are different so that the bit 3 cannot be positioned.

The applicant's former U.S. Pat. No. 7,159,493 discloses two slots defined in the socket and the two slots are not located on the same horizontal positions, and each slot extends toward ⅓ to ⅕ of the diameter of the socket. Two springs are mounted to the socket and each have an end section. The two respective end sections are inserted into the slots. An inner spring is located in the socket and its lower end is an enlarged section for securely engaged with the inside of the socket and the top end of the inner spring is a narrower section.

The two end sections are used to position two different types of bits such as the C type bit and the E type bit. The invention can also used to position the dual-end bit.

However, as shown in FIG. 11, the spring 29 sometimes is located at the mediate portion of the groove 2 of the bit 1 and the bit 1 shakes during use, this is because the range of the groove 2 is too large for the spring 29 so that the spring 29 cannot well position the bit 1. Furthermore, the spring 12 may impede the insertion of the bit 1.

FIG. 12 discloses the U.S. Pat. No. 6,860,489 which shows a socket 100 with a sleeve 110 and a bit 303 is inserted into the socket 100. A spring 101 is located in the socket 100 and an inclined slot 102 is defined in a mediate portion of the socket 100. Another spring 103 is mounted to the socket 100 and rested on a collar 104 of the socket 100. Two straight end sections 105, 106 are located on the top end of the spring 103 and the end section 106 is engaged with the slot 102.

The end section 106 is engaged with the groove 304 of the bit 303 and the other end section 105 contacts against the side of the bit 303. Again, the groove 304 of the bit 303 is too large for the end section 106 so that the bit 303 still shakes during use and the bit 303 tends to move upward. When removing the bit 303 from the socket 100, the end section 105 still presses on the bit 303. The invention is specifically designed to be cooperated with the E type bit and cannot well position the C type bit.

The present invention intends to provide a bit holder assembly which can precisely position the C type bit and E type bit, and the end second of the spring is located at the lower edge of the notches or groove of the two different types of bit.

### SUMMARY OF THE INVENTION

The present invention relates to a bit holder assembly and includes a socket with a sleeve movably mounted thereto and two springs are located between the socket and the sleeve. The two springs have two respective end sections which are engaged with two inclined slots defined in the wall of the socket. The two end sections protrude into ⅕ of the inner diameter of the socket. An inner spring is located in the socket. The axial height of the first slot is larger than or equal to the axial height of the notches of the bit, and the axial height of the second slot is larger than or equal to an axial height of the annular groove of the bit. An angle between the axis of the socket and the first and second slots is smaller than 60 degrees.

The primary object of the present invention is to provide a bit holder assembly which can precisely position the C type bit and E type bit.

Another object of the present invention is to provide a bit holder assembly wherein the end section of the spring is located at the lower edge of the notches or groove of the two different types of bit.

Yet another object of the present invention is to provide a bit holder assembly which allows the dual-end bit to be inserted into the socket and the inner spring does not deformed by or jammed with the bit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a bit inserted into the conventional socket;

FIG. 2 is a cross sectional view to show that the bit is positioned in the conventional socket;

FIG. 3 is a cross sectional view to show that the bit is pushed out by the spring in the conventional socket;

FIG. 4 shows that the end section of the spring of the conventional bit holder assembly is located at the underside of the bit;

FIG. 5 is a cross sectional view to show a bit is positioned in another conventional socket;

FIG. 6 shows the C type bit;

FIG. 7 shows the E type bit;

FIG. 8 is a cross sectional view to show a bit is positioned in yet another conventional socket;

FIG. 9 is a cross sectional view to show that the bit is pushed by the spring of the conventional socket in FIG. 8;

FIG. 10 is a cross sectional view to show that the dual-end bit is inserted into the conventional socket in FIG. 8 and deforms the spring in the socket;

FIG. 11 shows that the spring of conventional bit holder assembly is located in the groove of the bit;

FIG. 12 shows the bit holder assembly disclosed in U.S. Pat. No. 6,860,489;

FIG. 13 is an exploded view to show the bit holder assembly of the present invention;

FIG. 14 is a cross sectional view to show the bit holder assembly of the present invention;

FIG. 15 is a cross sectional view to show that an E type bit is inserted into the socket of the bit holder assembly of the present invention;

FIG. 16 is a cross sectional view, taken along line A-A in FIG. 15;

FIG. 17 is a cross sectional view to show that the E type bit is pushed by the inner spring of the bit holder assembly of the present invention;

FIG. 18 is a cross sectional view to show that a C type bit is inserted into the socket of the bit holder assembly of the present invention;

FIG. 19 is a cross sectional view, taken along line B-B in FIG. 18;

FIG. 20 is a cross sectional view to show that the C type bit is pushed by the inner spring of the bit holder assembly of the present invention;

FIG. 21 shows that the inside of the socket for receiving the inner spring is a circular hole;

FIG. 22 shows that the insertion hole of the socket for receiving the bit is a hexagonal hole;

FIG. 23 shows that the end section of the spring is located at the outer periphery of the lower end of the E type bit;

FIG. 24 shows that the end section of the spring is located at the outer periphery of the lower end of the C type bit;

FIG. 25 shows that the end section of the spring is located at the lower edge of the groove of the E type bit;

FIG. 26 shows that the end section of the spring is located at the lower edge of the notch of the C type bit;

FIG. 27 shows the second embodiment of the present invention;

FIG. 28 shows the third embodiment of the present invention, and

FIG. 29 shows the fourth embodiment of the present invention.

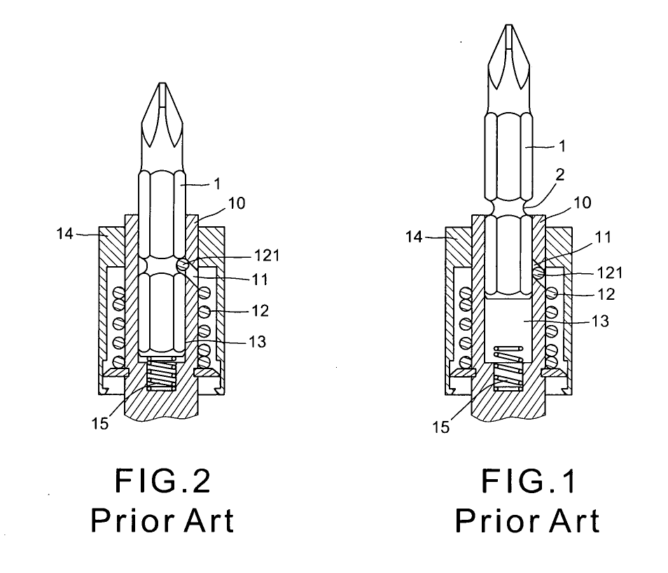

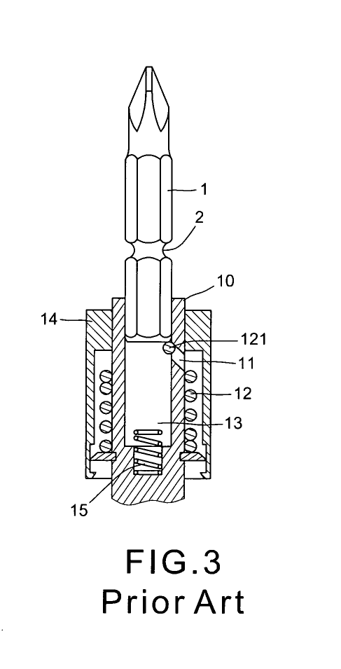

### DETAILED DESCRIPTION OF THE PREFERRED EMBODIMENT

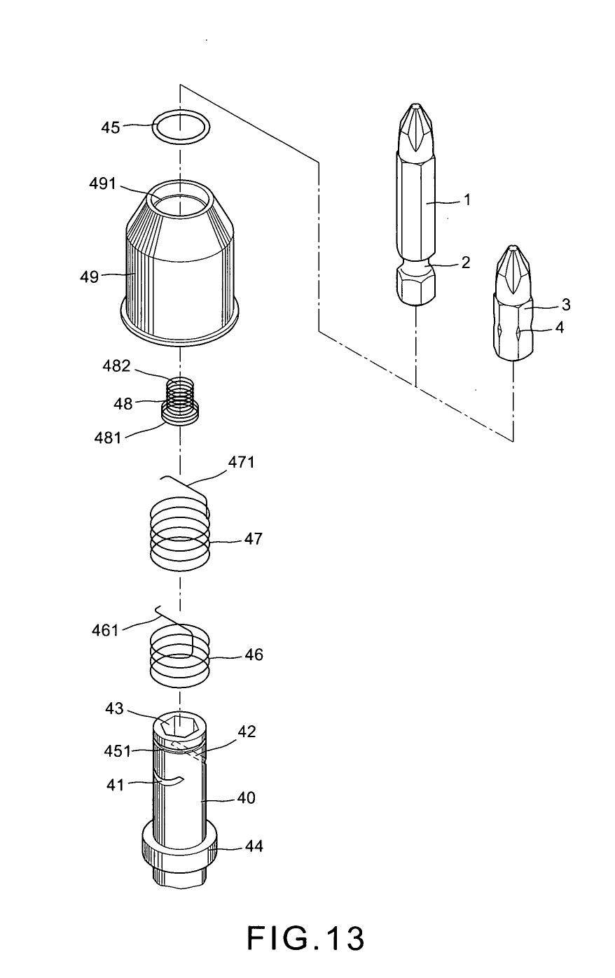

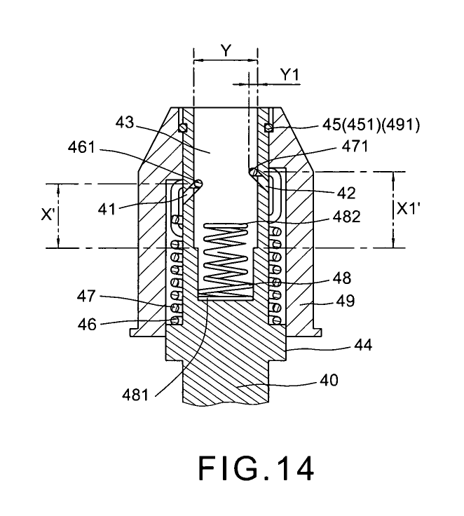

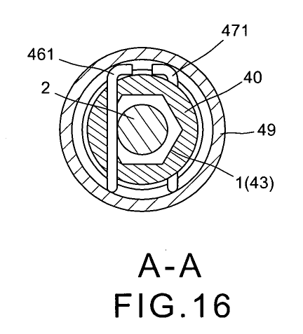

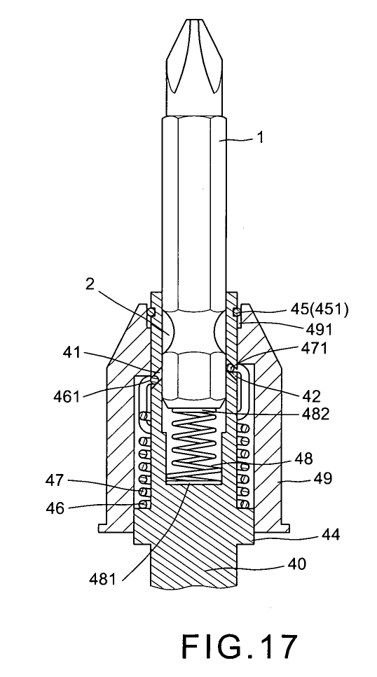

Referring to FIGS. 13 to 17, the bit holder assembly of the present invention comprises a socket 40 having an insertion hole 43 defined in a first end thereof and an inner spring 48 is located in the insertion hole 43. The insertion hole 43 can be a hexagonal hole or a circular hole. The inner spring 48 in the socket 40 includes an enlarged portion 481 and a narrow portion 482 which is located on a top of the enlarged portion 481. The enlarged portion 481 is securely engaged with the inside of the socket 40. The socket 40 is connected to a handle (not shown). A flange 44 extends radially outward from the outside of a second end of the socket 40. The socket 40 further includes an engaging groove 451 defined in the outside of the first end thereof and a collar 45 is engaged with the engaging groove 451. A first slot 41 and a second slot 42 are respectively defined in the wall of the socket 40 and located on different horizontal positions of the socket 40. In this embodiment, the first and second slots 41, 42 are inclined slots.

The first and second slots 41, 42 extend substantially ⅕ of an inner diameter of the socket 40. The axial height of the first slot 41 is designed by X′ and the axial height of the second slot 42 is X1′. A first spring 46 and a second spring 47 are respectively mounted to the socket 40. The first spring 46 has a first end section 461 and the second spring 47 has a second end section 471, wherein the first end section 461 and the second end section 471 are respectively engaged with the first and second slots 41, 42. The first and second springs 46, 47 are rested on the flange 44 of the socket 40. The inner diameter of the socket 40 is designed by Y and the distance that the first and second slots 41, 42 extending in the socket 40 is Y1. The relationship between the Y and Y1 is that Y/5 is larger than or equal to Y1, and the angle between the axis of the socket 40 and the first and second slots 41, 42 is smaller than 60 degrees. Therefore, the first and second end sections 461, 471 are able to precisely position the bits 1, 3. Because of the angle between the axis of the socket 40 and the first and second slots 41, 42 is smaller than 60 degrees, even if the bit 1/3 is pulled abnormally, the bit 1/3 does not separated from the socket 40.

A sleeve 49 is slidably mounted to the outside of the socket 40 and has a shoulder 491 formed in an inside of a first end of the sleeve 49, the shoulder 492 is engaged with the collar 45 to prevent the sleeve 49 from being separated from the socket 40.

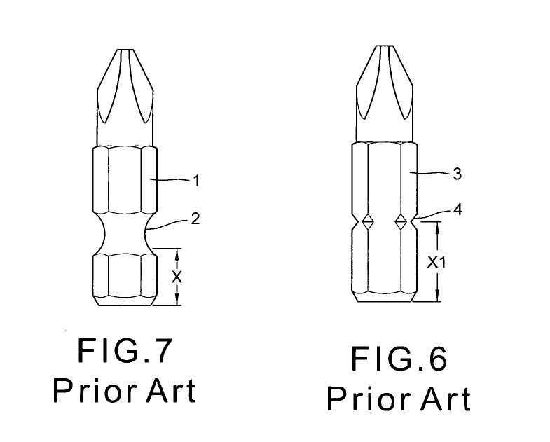

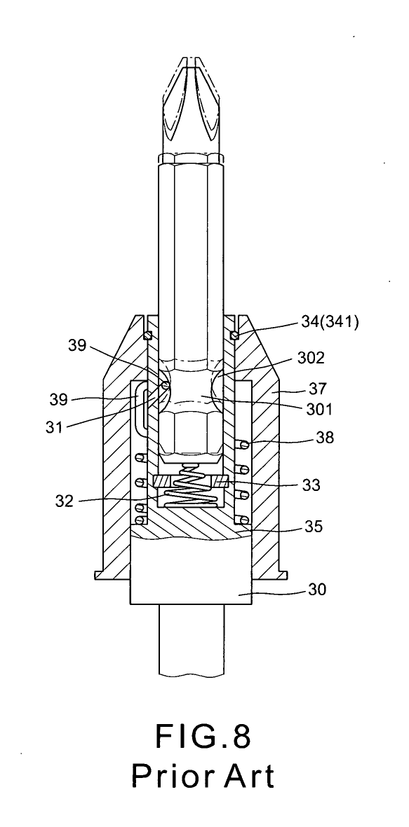

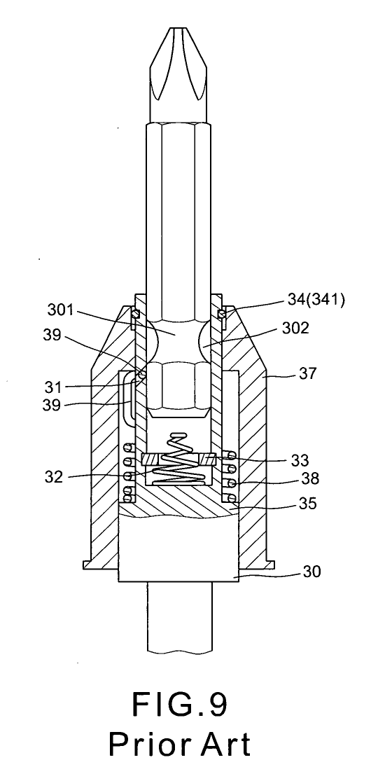

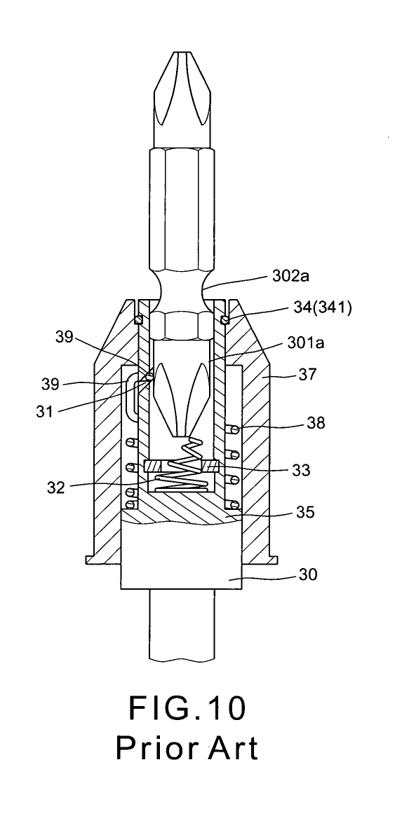

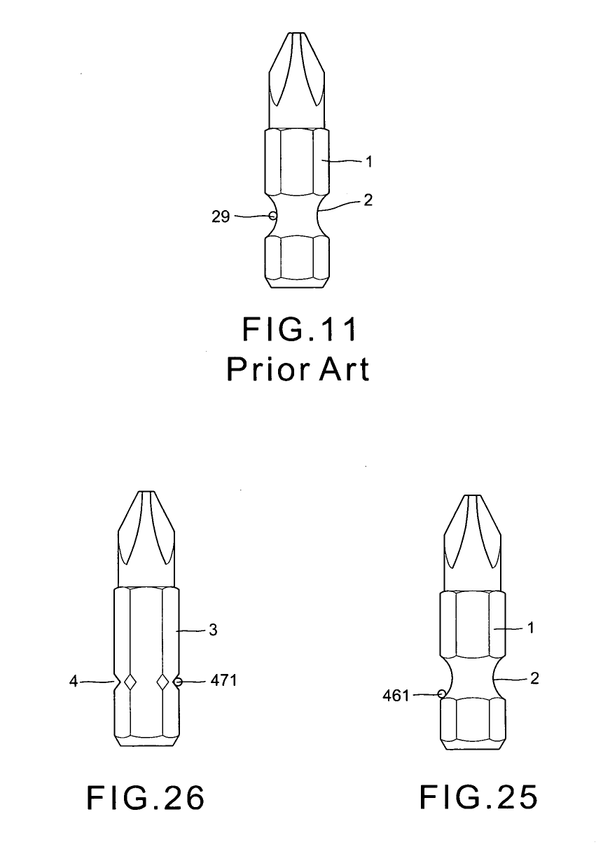

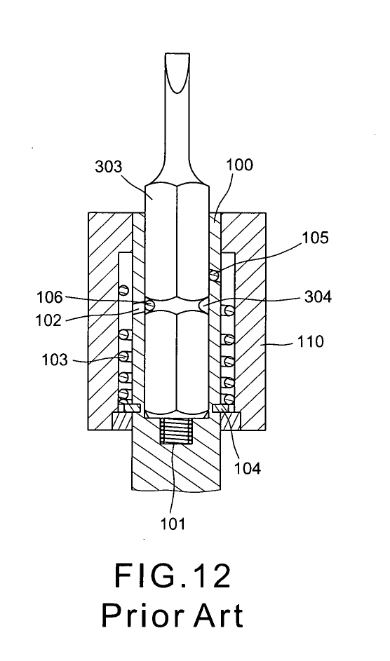

As shown in FIGS. 6, 7 and 14, the bit 1 (E type bit) has an annular groove 2 and the bit 3 (C type bit) has notches 4. The distance from the lower end of the bit 1 to the lower edge of the annular groove is designated by X, and the distance from the lower end of the bit 1 to the notches 4 is designated by X1. The X′ is larger than or equal to axial height X of the annular groove 2 of the bit 1. The X1′ is larger than or equal to the axial height X1 of the notches 4 of the bit 3.

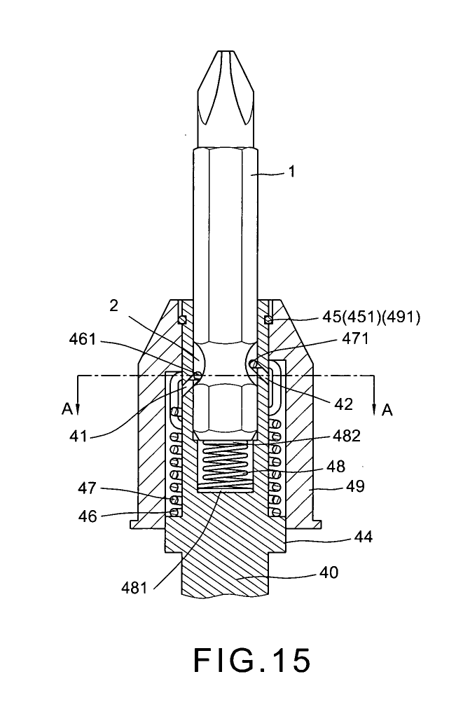

As shown in FIGS. 15 to 17, the bit 1 having the annular groove 2 is inserted into the insertion hole 43 of the socket 40, the first and second end sections 461, 471 in the socket 40 are pushed and lowered slightly to allow the bit 1 to be inserted into the socket 40 until the inner spring 48 is compressed by the bit 1. The first and second end sections 461, 471 are then moved into the first and second slots 41, 42 and are engaged with the annular groove 2. In this embodiment, the first end section 461 is located lower than the second end section 471, so that the first end section 461 is located at the lower edge of the annular groove 2 to position the bit 1 which cannot move upward. The higher second end section 471 is located at the mediate portion of the annular groove 2. By rotating the socket 40, the bit 1 is rotated to drive an object (not shown).

When pulling the sleeve 49, the first and second end sections 461, 471 are lowered along the first and second slots 41, 42. The first end section 461 is removed from the annular groove 2 and the inner spring 48 pushes the bit 1. In the meanwhile, the bit 1 is located in the socket 40 and the second end section 471 is still bias the bit 1. The bit 1 then can be picked out from the socket 40.

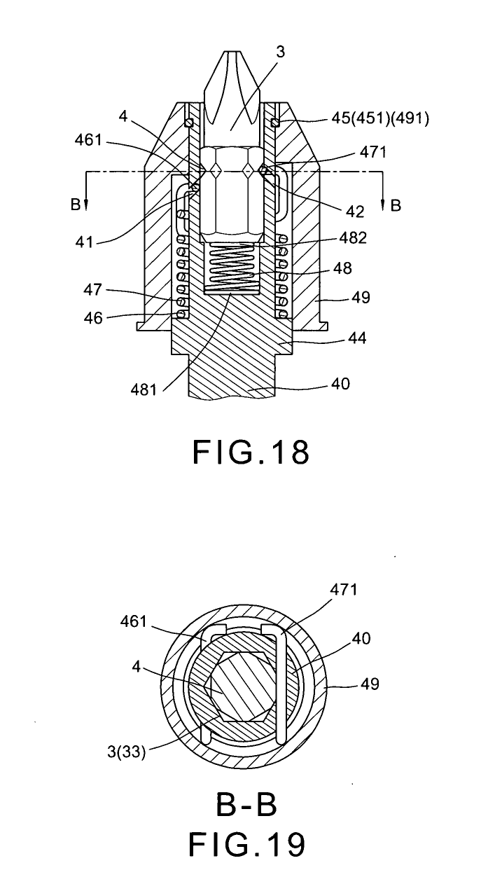

As shown in FIGS. 18, 19, when the bit is the bit 3 having notches 4 and is inserted into the insertion hole 43 of the socket 40, the first and second end sections 461, 471 in the socket 40 are pushed and lowered slightly to allow the bit 3 to be inserted into the socket 40 until the inner spring 48 is compressed by the bit 3. The first and second end sections 461, 471 are then moved into the first and second slots 41, 42 and are engaged with the notches 4. In this embodiment, the first end section 461 is located lower than the second end section 471, so that the second end section 471 is engaged with the notches 4 to position the bit 3 which cannot move upward. By rotating the socket 40, the bit 3 is rotated to drive an object (not shown).

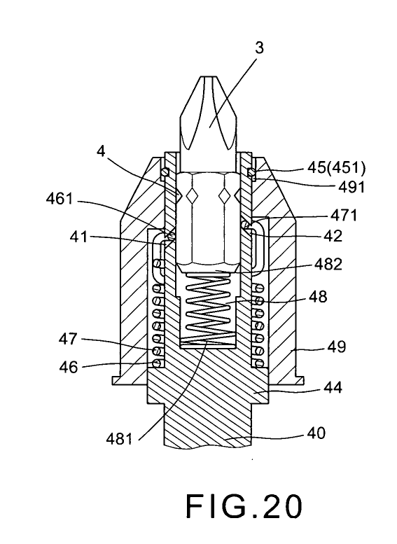

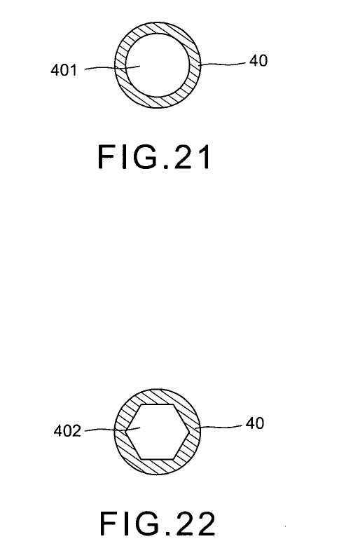

When pulling the sleeve 49 as shown in FIG. 20, the first and second end sections 461, 471 are lowered along the first and second slots 41, 42. The second end section 471 is removed from the notches 4 and the inner spring 48 pushes the bit 3. The bit 3 then can be picked out from the socket 40. As shown in FIGS. 21, 22, the inside of the socket 40 for receiving the inner spring 48 is a circular hole, and area for receiving the bit 1/3 is a hexagonal hole.

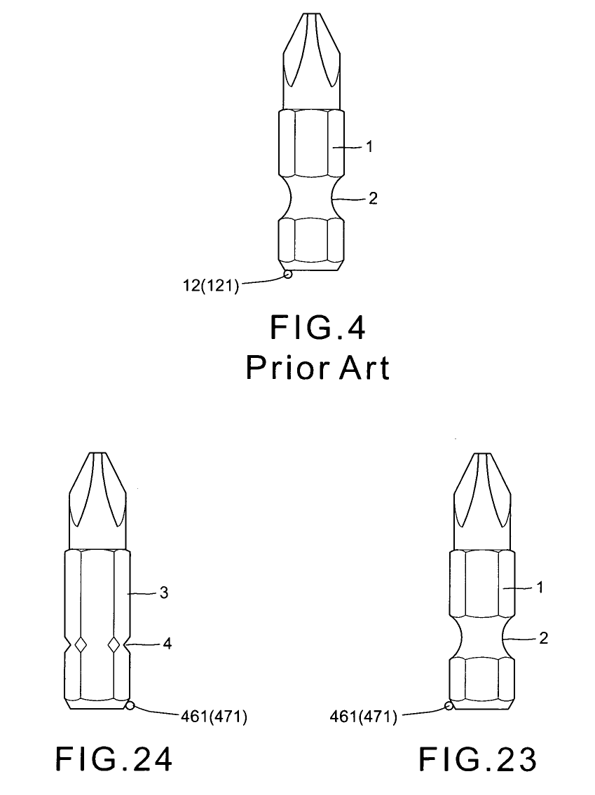

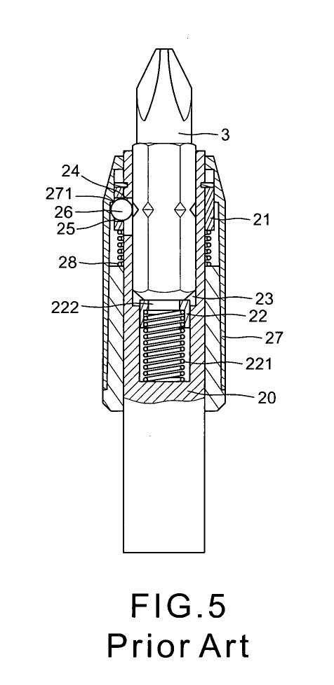

As shown in FIG. 23, when the bit 1 is to be pushed upward, the first and second end sections 461, 471 are located at the outer periphery of the lower end of the bit 1, rather than located at the underside of the bit, when compared with that disclosed in FIG. 4. Therefore, when another bit is to be inserted into the socket 40, the end sections 461, 471 do not impede the insertion of the bit 1. This is because that the first and second slots 41, 42 extend into about ⅕ of the inner diameter of the socket 40. Similarly, as shown in FIG. 24 which shows that the end section is located at the outer periphery of the lower end of the bit 3, rather than located at the underside of the bit 3. Therefore, when another bit is to be inserted into the socket 40, the end sections 461, 471 do not impede the insertion of the bit 3.

As shown in FIGS. 7, 14, 25, because X′ is larger than or equal to X, the first end section 461 is engaged at the lower edge of the annular groove 2 of the bit 1 and provides the maximum force to the bit 1 which is firmly positioned and does not shake. As shown in FIGS. 6, 14, 26, because X1′ is larger than or equal to X1, the second end section 471 is precisely engaged with the notches 4 of the bit 3. Therefore, the first and second end sections 461, 471 are able to precisely position the bits 1, 3 of different specifications.

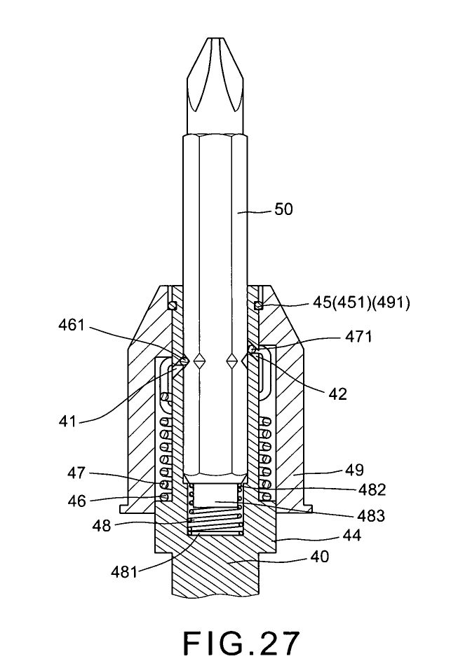

FIG. 27 shows that a magnet 483 is connected to the narrow portion 482 of the inner spring 48 and the magnet 483 attracts the bit 50 and the object such as screws can be attracted by the bit 50. The magnet 483 helps the insertion of the bit 50 into the socket 40. The force between the enlarged portion 481 and the inside of the socket 40 is larger than the magnetic force of the magnet 483 so that when the bit 50 is separated from the magnet 483, the inner spring 48 is still located in the socket 40.

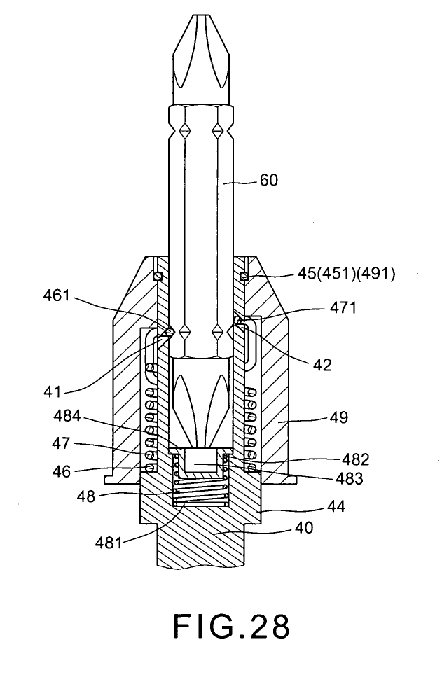

As shown in FIG. 28, a stop plate 484 can also be added to the inner spring 48 and the stop plate 484 allows that the dual-end bit 60 to be used in the socket 40. The end of the dual-end bit 60 is in contact with the stop plate 484 so that the inner spring 48 is not deformed by the bit 60. The magnetic force can also be available to the dual-end bit 60 to attract the object.

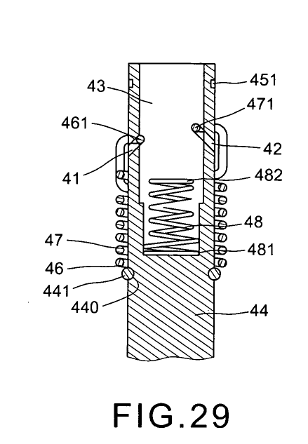

FIG. 29 shows that the socket 40 has a groove 440 defined in the outside thereof and a positioning ring 441 is engaged with the groove 440. The first and second springs 46, 47 contact against the positioning ring 441.

While we have shown and described the embodiment in accordance with the present invention, it should be clear to those skilled in the art that further embodiments may be made without departing from the scope of the present invention.

What is claimed is:

1. A bit holder assembly comprising:
a socket having an insertion hole defined in a first end thereof and an inner spring located in the insertion hole, a collar is mounted to an outside of the first end of the socket and a flange extending radially outward from the outside of a second end of the socket, a first slot and a second slot respectively defined in the socket and located on different horizontal positions of the socket, the first and second slots being inclined slots;
a sleeve mounted to the outside of the socket and having a shoulder formed in an inside of a first end of the sleeve, the shoulder being engaged with the collar;
a first spring and a second spring respectively mounted to the socket, the first spring having a first end section and the second spring having a second end section, the first end section and the second end section respectively engaged with the first and second slots;
a bit having notches (C type bit) or annular groove (E type bit);
the first and second slots extending substantially ⅕ of an inner diameter of the socket, an axial height of the first slot being larger than or equal to an axial height of the notches of the bit, an axial height of the second slot being larger than or equal to an axial height of the annular groove of the bit, an angle between an axis of the socket and the first and second slots being smaller than 60 degrees, the first end section engaged with a lower edge of the annular groove of the bit or the second end section engaged with the notches of the bit, the first/section end sections located on an outer periphery of a lower end of the bit.

2. The bit holder assembly as claimed in claim 1, wherein the inner spring in the socket includes an enlarged portion and a narrow portion which is located on a top of the enlarged portion, the enlarged portion is securely engaged with the inside of the socket.

3. The bit holder assembly as claimed in claim 1, wherein the first and second springs contact against the flange of the socket.

4. The bit holder assembly as claimed in claim 1, wherein the socket has a groove defined in the outside thereof and a positioning ring is engaged with the groove, the first and second springs contact against the positioning ring.

5. The bit holder assembly as claimed in claim 1, wherein the socket includes an engaging groove defined in the outside of the first end thereof and the collar is engaged with the engaging groove.
